(19) United States
(12) Patent Application Publication
(10) Pub. No.: US 2007/0221747 A1
(43) Pub. Date: Sep. 27, 2007

(54) SUPER IMPOSED SIGNAL FOR AN ACTUATOR AND HEATER OF A FUEL INJECTOR

(75) Inventors: Michael J. Hornby, Williamsburg, VA (US); John F. Nally, Williamsburg, VA (US); Hamid Sayar, Newport News, VA (US); Perry Robert Czimmek, Williamsburg, VA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens VDO Automotive Corporation, Auburn Hills, MI (US)

(21) Appl. No.: 11/689,078

(22) Filed: Mar. 21, 2007

Related U.S. Application Data
(60) Provisional application No. 60/784,696, filed on Mar. 22, 2006.

(51) Int. Cl. B05B 1/24

(52) U.S. Cl. 239/135

(57) ABSTRACT

A fuel injector includes an actuator and a heater. A common driver provides a first signal superimposed, for example, over a second signal to power both the actuator and the heater.

### CROSS REFERENCE TO RELATED APPLICATION

The application claims priority to U.S. Provisional Application No. 60/784,696 which was filed on Mar. 22, 2006.

### BACKGROUND

This application generally relates to a fuel injector for a combustion engine. More particularly, this invention relates to a fuel injector that heats fuel to aid the combustion process.

Combustion engine suppliers continually strive to improve emissions and combustion performance. Once method of improving both emissions and combustion performance includes heating or vaporizing fuel prior to entering the combustion chamber. Starting a combustion engine often results in undesirably high emissions since the engine has not yet attained an optimal operating temperature. Heating the fuel replicates operation of a hot engine, and therefore improves performance. Further, alternative fuels such as ethanol can perform poorly in cold conditions, and therefore also may benefit from pre-heating of fuel.

Various methods of heating fuel at a fuel injector have been employed. Such methods include the use of a ceramic heater, or resistively heated capillary tube within which the fuel passes. In another example, positive temperature coefficient (PTC) heating elements have been used. One disadvantage of these devices is that that they do not heat the fuel quickly or hot enough to have the desired effect at start-up. Another disadvantage of prior art fuel injector heaters is that the wires to the heater are often in the fuel flow path, which is undesirable if the insulation about the wires fails. These wires also create an additional potential fuel leakage path.

What is needed is a fuel injector having a heater that does not create additional fuel leak paths while still providing rapid heating and vaporization of fuel.

### SUMMARY

A fuel injector includes an actuator for selectively moving a pole-piece between open and closed positions to provide fuel to a combustion chamber, for example. The fuel injector also includes a heater for rapidly heating the fuel within the fuel injector. The actuator and heater utilize different signals to actuate the pole-piece and heat the fuel, respectively. In one example, a common driver is used to provide the signals to the actuator and the heater. In one example, a DC signal is provided from the driver to the actuator to move the pole-piece. The driver superimposes an AC signal on the DC signal. The AC signal is used to power the heater. In one example, the heater is an inductive heater that inductively heats a structure near the fuel within the fuel injector.

A filter is arranged between the driver and the actuator and the heater to separate the signals prior to providing the respective signals to the actuator and heater.

These and other features can be best understood from the following specification and drawings, the following of which is a brief description.

### BRIEF DESCRIPTION OF THE DRAWINGS

FIG. 1 is a cross-section of an example fuel injector assembly.

FIG. 2 a schematic view of the example fuel injector assembly.

FIG. 3A schematically depicts a DC signal used to modulate an actuator with an AC signal superimposed on the DC signal to provide inductive heating.

FIG. 3B schematically depicts a DC signal used to open and close the fuel injector without providing inductive heat.

### DETAILED DESCRIPTION OF THE PREFERRED EMBODIMENT

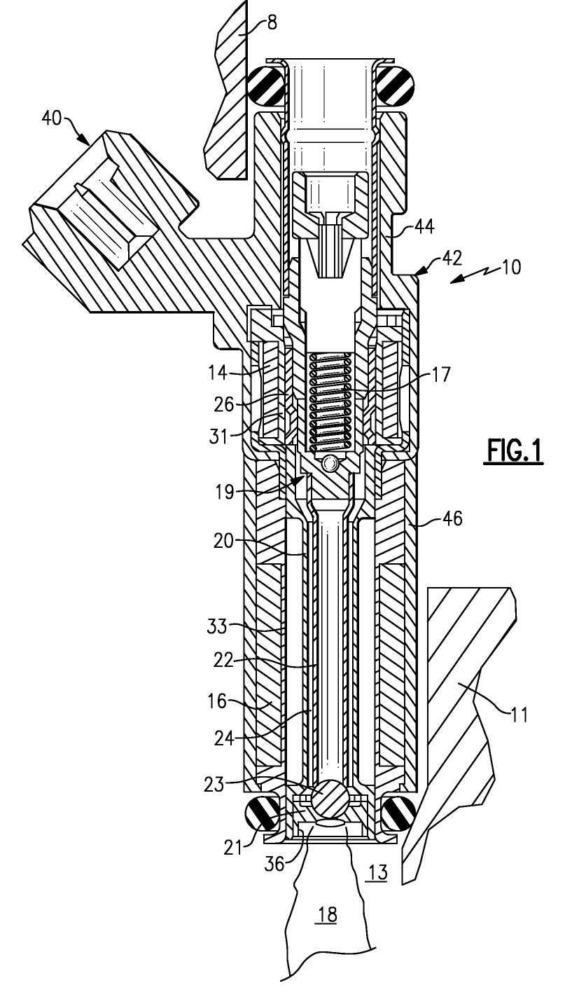

An example fuel injector 10 is shown in FIG. 1. Typically, the fuel injector 10 receives fuel from a fuel rail 8. The fuel injector 10 provides fuel 18 to a combustion chamber 13 of a cylinder head 11, for example, through an outlet 36. Typically, it is desirable to provide well atomized fuel from the outlet 36 to the combustion chamber 13 for more complete combustion and reduced emissions, particularly during cold start conditions.

The fuel injector 10 includes an actuator having a first coil 14 for actuating a pole-piece 19 between open and closed positions. The pole-piece 19 includes an armature 26 interconnected to an armature tube 22. The armature tube 22 supports a ball 23 that is received by a seat 22 when the pole-piece 19 is in a closed position, which is shown in the figures. A return spring 17 biases the ball 23 to the closed position. The ball 23 is spaced from the seat 21 in the open position to provide fuel to the combustion chamber 13.

A first barrier 31 is provided between the armature 26 and the first coil 14 and insulates the first coil 14 from the fuel flow path within the fuel injector 10. Electrical wires (shown in FIG. 2) are connected between the first coil 14 and pins provided by a connector 40 of a shell 42 (FIG. 1). In one example, the shell 42 includes first and second portions 44, 46 that are over-molded plastic arranged about the internal fuel injector components.

A second coil 16 is arranged near the outlet 36 and coaxial with the first coil 14 in the example shown. The second coil 16 heats the fuel within an annular flow path 24 arranged between a valve body 20 and the armature tube 22. In one example, the second coil 16 inductively heats the valve body 20 and/or the armature tube 22 inductively. In the example, a second barrier 33 seals the second coil 16 relative to the internal passages of the fuel injector 10. In one example, the second coil 16 is arranged between the second barrier 33 and the second portion 46. The wires from the second coil 16 to the connector 40 do not extend to the interior passages of the fuel injector carrying fuel, but rather are contained within the shell 42 outside of the annular flow path 24, for example.

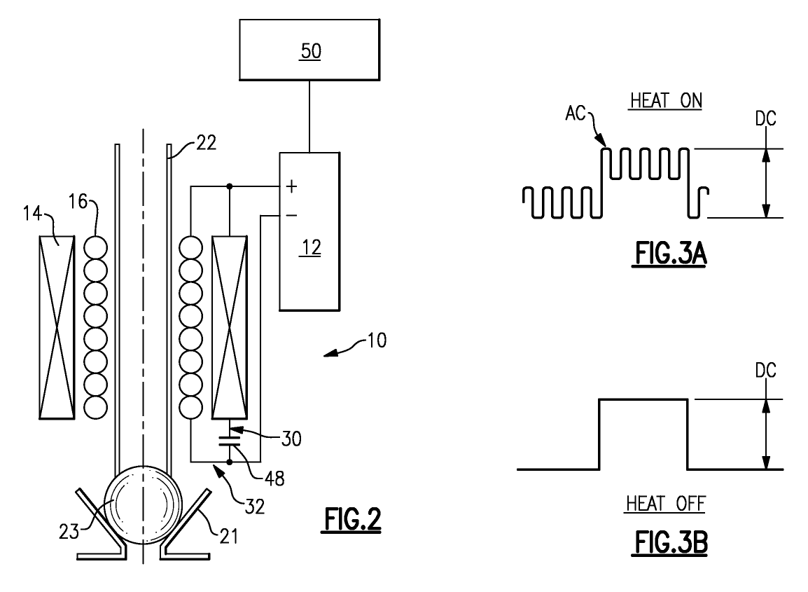

In one example, a driver 12 provides a DC signal 30 to the first coil 14, which is shown schematically in FIG. 2. In one example shown in FIG. 3B, the DC signal 30 is a square tooth wave modulated between 0 and 14 volts. The DC signal 30 generates a first magnetic field that induces an axial movement of the armature 26, as is known.

Referring to FIG. 2, the driver 12 is connected to the second coil 16 to provide an AC signal 32, for example 70 volts at 40 kHz, to the second coil 16. The AC signal 32 produces a time varying and reversing magnetic field that heats up the components within the field. Heat is generated within the valve body 20 and/or armature tube 22 by hysteretic and eddy-current losses by the magnetic field. The amount of heat generated is responsive to the specific resistivity of the material being acted upon and the generation of an alternating flux. The time varying magnetic field produces a flux flow in the surface of the material that alternates direction to generate heat. The higher resistivity of the material, the better the generation of heat responsive to the magnetic field. The heated valve body 20 and/or armature tube 22 rapidly transfers heat to the fuel within the annular flow path 24 to provide a well vaporized fuel exiting the outlet 36 when the pole-piece 19 is opened.

A single driver 12 is used to power both the first and second coils 14, 16. In this manner, the number of components may be reduced, and the number of wires required for each injector can be reduced to two in the example. A filter 48 is arranged between the first and second coils 14, 16 and the driver 12. In one example, the filter 48 is a capacitor that acts as a high pass filter, which filters out high frequencies, such as the AC signal. The driver 12 sends a DC signal with an AC signal superimposed on the DC signal to the filter 48, as shown in FIG. 3A, to provide heat using the second coil 16. The filter 48 blocks the AC signal and allows the DC signal to pass to the first coil 14. In this manner, the DC signal actuates the armature 26. The AC signal 32, however, is sent to the second coil 16, which induces a magnetic field that conductively heats the valve body 20 and/or armature tube 22.

The driver 12 and the controller 50 are exterior to the fuel injector 10 in the example shown. The driver 12 can be separate structures and/or software, as shown, or integrated with one another and/or the controller 50.

Although a preferred embodiment has been disclosed, a worker of ordinary skill in this art would recognize that certain modifications would come within the scope of the claims. For that reason, the following claims should be studied to determine their true scope and content.

What is claimed is:

1. A fuel injector assembly comprising:
an actuator;
a heater; and
a driver in communication with the actuator and heater configured to produce first and second signals, the actuator responsive to the first signal, and the heater responsive to the second signal.

2. The fuel injector assembly according to claim 1, wherein the first and second signals are respectively DC and AC signals.

3. The fuel injector assembly according to claim 1, wherein the AC signal is superimposed on the DC signal.

4. The fuel injector assembly according to claim 1 comprising a filter arranged between the driver and at least one of the actuator and the heater, the filter permitting one of the signals to pass to one of the actuator and heater and the filter blocking the other signal.

5. The fuel injector assembly according to claim 4, wherein the filter is a high pass filter.

6. The fuel injector assembly according to claim 5, wherein the filter is a capacitor.

7. The fuel injector assembly according to claim 1 comprising a pole-piece movable between open and closed positions to selectively provide fuel in response to a magnetic field generated by the actuator in response to the first signal.

8. The fuel injector assembly according to claim 1 comprising a structure arranged near a fuel flow path, the structure heated in response to a magnetic field produced by the heater in response to the second signal.

9. The fuel injector assembly according to claim 8, wherein the heater is an inductive heater.

10. The fuel injector assembly according to claim 1, wherein in a pair of wires from the driver supply the first and second signals to the actuator and heater.
